(19) United States
(12) Patent Application Publication
(10) Pub. No.: US 2025/0247754 A1
(43) Pub. Date: Jul. 31, 2025

(54) CELL SELECTION AND RESELECTION IN LEO-BASED NR-NTN

(71) Applicant: MediaTek Singapore Pte. Ltd., Singapore (SG)

(72) Inventors: Abhishek ROY, San Jose, CA (US); Chia-Chun HSU, Hsinchu City (TW)

(21) Appl. No.: 19/184,032

(22) Filed: Apr. 21, 2025

Related U.S. Application Data
(63) Continuation of application No. 17/905,705, filed on Sep. 6, 2022.
(60) Provisional application No. 62/987,957, filed on Mar. 11, 2020.

(51) Int. Cl. H04W 36/06; H04B 7/195; H04W 36/00; H04W 48/20; H04W 84/06

(52) U.S. Cl. CPC H04W 36/06; H04B 7/195; H04W 36/0085; H04W 48/20; H04W 84/06

(57) ABSTRACT

Methods for a New Radio (NR)-based, Low Earth Orbit (LEO) Non-Terrestrial Networks (NTN) are proposed to improve cell selection and reselection by using satellite assistance information. Different from traditional 5G New Radio systems, the LEO NTN can provide the next cell information along the satellite trajectory using System Information Broadcast (SIB). The assistance information can include satellite's long term ephemeris in the format of Position Velocity (PV) information or details of satellite's other orbital parameters. During TN-NTN join coverage, as TN cells are expected to have a better coverage then NTN cells, the network can assign higher priority to the TN cells over NTN cells. Similarly, for a mobility involving earth-fixed and earth-moving beams (cells), earth-fixed cells can be prioritized over earth-moving beams for cell reselection.

### CROSS REFERENCE TO RELATED APPLICATIONS

This application is a Continuation of pending U.S. application Ser. No. 17/905,705, filed on Sep. 6, 2022, which is a 371 National Phase of pending PCT Application No. PCT/CN2021/080144, filed on Mar. 11, 2021, which claims priority under 35 U.S.C. § 119 from U.S. Provisional Application No. 62/987,957, entitled “Cell Selection/Re-selection in LEO-based NR-NTN,” filed on Mar. 11, 2020, the subject matter of which is incorporated herein by reference.

### TECHNICAL FIELD

The disclosed embodiments relate generally to wireless network communications, and, more particularly, to cell selection and cell reselection improvements in New-Radio NR-based, LEO Non-Terrestrial Networks (NTNs).

### BACKGROUND

There is increasing interest and participation in 3GPP from the satellite communication industry, with companies and organizations convinced of the market potential for an integrated satellite and terrestrial network infrastructure in the context of 3GPP 5G. Satellites refer to Space borne vehicles in Low Earth Orbits (LEO), Medium Earth Orbits (MEO), Geostationary Earth Orbit (GEO) or in Highly Elliptical Orbits (HEO).5G standards make Non-Terrestrial Networks (NTN)—including satellite segments—a recognized part of 3GPP 5G connectivity infrastructure. A low Earth orbit is an Earth-centered orbit with an altitude of 2,000 km or less, or with at least 11.25 periods per day and an eccentricity less than 0.25. Most of the manmade objects in outer space are in LEO. Low Earth Orbit (LEO) satellites orbit around the earth at a high speed (mobility), but over a predictable or deterministic orbit.

In 4G Long-Term Evolution (LTE) and 5G new radio (NR) networks, an evolved universal terrestrial radio access network (E-UTRAN) includes a plurality of base stations, e.g., evolved Node-Bs (eNodeBs) communicating with a plurality of mobile stations referred as user equipment (UEs). In 5G New Radio (NR), the base stations are also referred to as gNodeBs or gNBs. For UEs in radio resource control (RRC) Idle mode mobility, cell selection is the procedure through which a UE picks up a specific cell for initial registration after power on. One major objective of cell selection is to quickly camp on to a candidate cell after initial power on. On the other hand, cell reselection is the mechanism to change cell after UE is camped on a cell and stays in idle mode. Cell reselection is a continuous process through which UE searches and camps on a better cell than its current cell. As signal strength, measured in terms of reference signal received power (RSRP) and reference signal received quality (RSRQ), falls below certain threshold, the UE starts measuring the signal strength and quality of neighboring cells. For inter-frequency reselection, the UE first selects the frequency having highest priority. Within the same frequency (for both inter-frequency and intra-frequency reselection), the UE ranks the cells based on their signal strength and re-selects the cell having the highest rank.

Mobility in LEO satellite-based NTN can be quite different from terrestrial networks. In terrestrial networks, cells are fixed but UEs may move in different trajectories. On the other hand, in NTN, most of the LEO satellites travel at a very high speed relative to the earth's ground, while the UE movements are relatively slow and negligible. The satellite's speed is too high to compare with the speed of any mobile UE, including airplane users. For example, in LEO scenario with 600 km height, a speed of 7.56 km/sec and a beam spot diameter of around 70 km, there will be frequent cell reselection at less than every 10 seconds. Thus, for LEO satellites, the cells are moving over time, albeit in a predictable manner. Hence, LEO satellites can estimate the target cell based on its own movement speed, direction and height from the ground, instead of relying on UE's measurement reports. Once the LEO satellite's cells or beams are swept past, most (if not all) UEs need to re-select the same cell or beam. The network can estimate UEs' locations by using Global Navigation Satellite System (GNSS) or by capturing location information from the core networks.

Naturally, high speed of LEO satellites will incur frequent cell re-selection. However, in the NTN the dynamics of signal strength and quality, measured in terms of RSRP and RSRQ could be quite different as there could be slow signal degradation, followed by abrupt loss of coverage of coverage holes. Hence, the cell reselection process in NR-NTN needs further improvement to assist the UE's cell search process, e.g., additional network and satellite assistance will be beneficial for the UE to perform improved cell reselection.

### SUMMARY

Low Earth Orbit (LEO) satellites orbit around the earth at a high speed (mobility), but over a predictable or deterministic orbit. This innovation describes methods for a New Radio (NR)-based, LEO Non-Terrestrial Networks (NTN) to improve cell selection and reselection by using satellite assistance information. Different from traditional 5G New Radio systems, the LEO NTN can provide candidate cell information along the satellite trajectory using System Information Broadcast (SIB). The assistance information can include satellite's long term ephemeris in the format of Position Velocity (PV) information or details of satellite's other orbital parameters. Pre-provisioning a subset of some important parameters is also possible. During TN-NTN join coverage, as TN cells are expected to have a better coverage then NTN cells, the network can assign higher priority to the TN cells over NTN cells. Similarly, for a mobility involving earth-fixed and earth-moving beams (cells), earth-fixed cells can be prioritized over earth-moving beams for cell reselection.

In one embodiment, a UE camps on a current cell in a new radio (NR) based Low Earth Orbit (LEO) Non-Terrestrial Network (NTN). The UE receives assistance information from LEO satellites. The UE may stay in radio resource control (RRC) Idle mode, and the assistance information comprises satellite ephemeris information. The UE performs measurements over candidate cells for cell reselection. The candidate cells are determined based on the assistance information that indicates the candidate cells. The satellite ephemeris information may be either based on position and velocity (P,V) information, or based on satellite's orbital parameters.

Other embodiments and advantages are described in the detailed description below. This summary does not purport to define the invention. The invention is defined by the claims.

### BRIEF DESCRIPTION OF THE DRAWINGS

FIG. 1 illustrates an exemplary 5G new radio NR (NR) wireless communication system that supports improved cell selection and reselection procedure in Low Earth Orbit (LEO) Non-Terrestrial Network (NTN) in accordance with a novel aspect.

FIG. 2 is a simplified block diagram of a wireless transmitting device and a receiving device in accordance with embodiments of the present invention.

FIG. 3 illustrates an example of Low Earth Orbit (LEO) Non-Terrestrial Network (NTN) providing next cell and ephemeris information for improved cell reselection in accordance with one novel aspect.

FIG. 4 illustrates examples of ephemeris information with Keplerian Orbital parameters.

FIG. 5 illustrates embodiments of improved cell reselection under satellite coverage discontinuity in accordance with one novel aspect.

FIG. 6 illustrates examples of earth-fixed beams and earth-moving beams in LEO NTN and corresponding cell reselection procedure.

FIG. 7 is a flow chart of a method of performing improved cell reselection procedure in NR-based LEO NTN in accordance with one novel aspect.

### DETAILED DESCRIPTION

Reference will now be made in detail to some embodiments of the invention, examples of which are illustrated in the accompanying drawings.

FIG. 1 illustrates an exemplary 5G new radio NR (NR) wireless communication system 100 that supports improved cell selection and reselection procedure in Low Earth Orbit (LEO) Non-Terrestrial Network (NTN) in accordance with a novel aspect.NR wireless communication system 100 comprises a plurality of base stations gNBs 101-104, a plurality of user equipments (UEs) 110, and a plurality of gateways 121-122. In the example of FIG. 1, the base stations gNBs 101-104 are LEO satellites orbiting around the earth at a high speed (mobility), but over a predictable or deterministic orbit. Mobility in LEO satellite-based NTN can be quite different from terrestrial networks. For UEs in radio resource control (RRC) Idle mode mobility, cell selection is the procedure through which a UE picks up a specific cell for initial registration after power on. One major objective of cell selection is to quickly camp on to a candidate cell after initial power on. On the other hand, cell reselection is the mechanism to change cell after UE is camped on a cell and stays in RRC idle mode. Cell reselection is a continuous process through which the UE searches and camps on a better cell than its current cell.

Naturally, the high speed of LEO satellites will result in frequent cell reselection. However, due to the dynamics of signal strength and quality in NTN, the RSRP and RSRQ measurements could be quite different as there could be slow signal degradation, followed by abrupt loss of coverage of coverage holes. Hence, the cell reselection process in NR-NTN needs further improvement to assist the UE's cell search process. In general, RRC Idle mode mobility and handover in LEO-satellite based NTN can be characterized by several distinct characteristics. First, due to predictable mobility patterns of satellites, LEO-NTN can estimate the satellites locations over time. Second, based on the UEs' locations and movement of satellite cells, LEO-NTN can provide assistance to the UE for cell re-selection. Third, the assistance involves providing the next cell information to the UE.

Accordingly, based on the above-mentioned characteristics, cell reselection in RRC Idle mode NTN can be improved by providing satellite's assistance, e.g., next cell information, e.g., candidate cell ID, to the UE. In the example of FIG. 1, the LEO-satellite based NTN/satellites provide UE 110 the next cell information along the satellite trajectory for cell reselection. The assistance information can include satellite's long term ephemeris in the format of Position Velocity (PV) information or details of satellite's other orbital parameters. The ephemeris information can either be provisioned, e.g. pre-provisioned, to UE 110 using USIM, or be provided to UE 110 using System Information Broadcast, e.g., SIB-9 or a dedicated NTN-specific SIB.UE 110 itself can use the assistance information to estimate the candidate cells for reselection along the LEO satellite's orbit. Furthermore, during TN-NTN join coverage, the network can assign higher priority to the TN cells over NTN cells. Similarly, earth-fixed cells can be prioritized over earth-moving cells for cell reselection. Note that NTN cells are also referred to as beams in the present invention, as one NTN cell corresponds to one satellite beam.

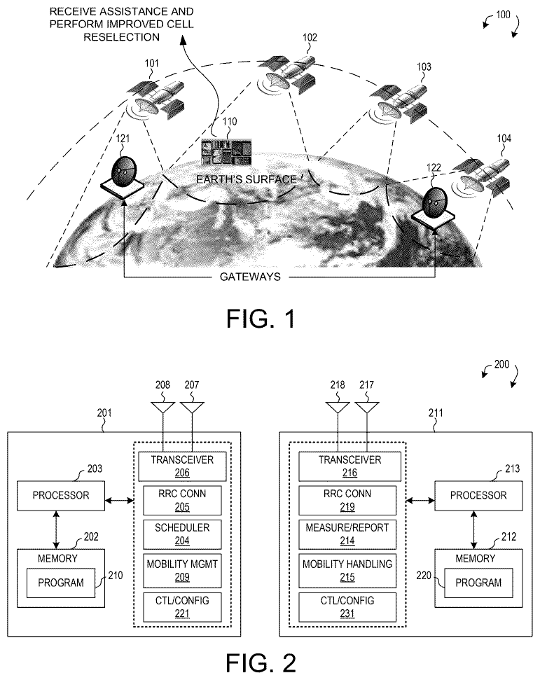

FIG. 2 is a simplified block diagram of wireless devices 201 and 211 in accordance with embodiments of the present invention. For wireless device 201 (e.g., a base station), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210to control the operations of device 201.

Similarly, for wireless device 211 (e.g., a user equipment), antennae217 and 218transmit and receive RF signals. RF transceiver module 216, coupled with the antennae, receives RF signals from the antennae, converts them to baseband signals and sends them to processor213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220to control the operations of the wireless device 211.

The wireless devices 201 and211 also include several functional modules and circuits that can be implemented and configured to perform embodiments of the present invention. In the example of FIG. 2, wireless device 201 is a base station that includes an RRC connection handling module 205, a scheduler 204, a mobility management module 209, and a control and configuration circuit 221. Wireless device 211 is a UE that includes a measurement module 219, a measurement reporting module 214, a handover handling module 215, and a control and configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow base station 201 and user equipment 211 to perform embodiments of the present invention.

In one example, the base station 201 establishes an RRC connection with the UE 211 via RRC connection handling circuit 205, schedules downlink and uplink transmission for UEs via scheduler 204, performs mobility and handover management via mobility management module 209, and provides measurement and reporting configuration information to UEs via configuration circuit 221. The UE 211 handles RRC connection via RRC connection handling circuit 219, performs measurements and reports measurement results via measurement and reporting module 214, performs cell selection and reselection via mobility handling module215, and obtains measurement and assistance information via control and configuration circuit 231. In one novel aspect, base station 201 provides the next cell information along the satellite trajectory to UE 211. The assistance information can include satellite's long term ephemeris in the format of Position Velocity (PV) information or details of satellite's other orbital parameters for improved cell reselection.

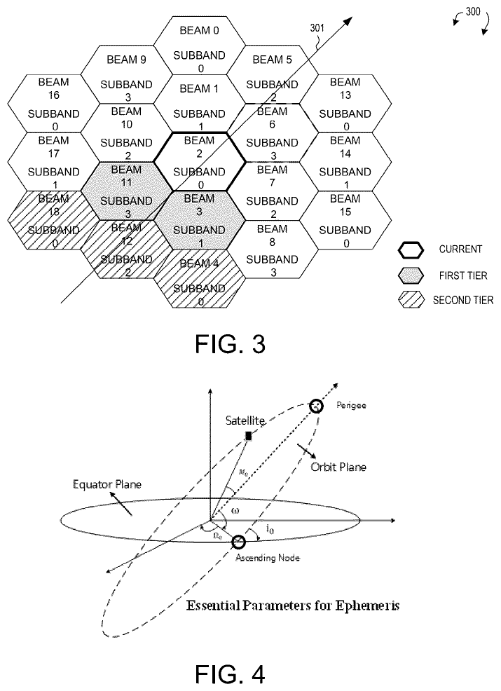

FIG. 3 illustrates an example of Low Earth Orbit (LEO) Non-Terrestrial Network (NTN) 300 providing next cell and ephemeris information for improved cell reselection in accordance with one novel aspect. The LEO-NTN can provide the ephemeris information to the UE. Satellites transmit information about their location (current and predicted), timing and condition by using as ephemeris data. The ephemeris data can be used by the receivers to estimate position of each satellite in orbit, and information about the time and status of the entire satellite constellation, called the almanac. The ephemeris data can also be used to predict future satellite conditions (for a given place and time) providing a tool for planning when (or when not) to schedule GPS data collection. The ephemeris information could be based on position, velocity (P, V), next beam (e.g., candidate cell) information, in the form of Physical Cell ID, intraFreqWhiteCellList, InterFreqWhiteCellList, starting frequency, periodicity and symbol offset, synchronization signal block (SSB) information of the candidate beams, the starting frequency domain position periodicity and symbol offset, difference of frequency pre-compensation value between the current serving beam and the beam candidates as the next beam.

As signal strength, measured in terms of reference signal received power (RSRP) and reference signal received quality (RSRQ), falls below certain threshold, the UE starts measuring the signal strength and quality of neighboring cells for cell reselection. In the example of FIG. 3, if beam 2 is the present current beam (cell), the next candidate beam (cell) should be beam 11 or beam 3 based on the ephemeris information, depicted by arrow 301 as the satellite moving direction. Network and satellite can provide the nexttier candidate cell information of these beams to the UE, and the UE need to perform measurements and cell searching only on the candidate beam 11 or beam 3.Note that without such assistance information, the UE will need to search all the neighboring cells for cell reselection, e.g., beam 3, beam 11, beam 10, beam 1, beam 6, and beam 7. The assistance information could be extended to the second tier Physical cell IDs of the beam candidates. This will also include SSB information of the beam candidates as the next beam. For example, the network and satellite can indicate beam 12, beam 18 or beam 4 as the beams of the second tier candidate cell (i.e. next to next beams).

FIG. 4 illustrates examples of ephemeris information with Keplerian Orbital parameters. Instead of PV information, the long term ephemeris can also contain the details of satellite's orbital parameters, e.g. cell center location, cell diameter, perigee, ascending node. The details of the Keplerian orbital parameters are described below. Eccentricity: Shape of the ellipse, describing how much it is elongated compared to a circle (e=0 circular orbit; e<1 elliptical orbit; e>1 hyperbolic trajectory; e=1 parabolic trajectory). Semimajor axis: the sum of the periapsis (point of closest approach) and apoapsis (point of farthest excursion) distances divided by two. Typical Galileo orbits semimajor axis value is around 29,500 km. Inclination (i): vertical tilt of the ellipse with respect to the reference plane (equatorial plane), measured at the ascending node (where the orbit passes upward through the equatorial plane). Typical Galileo orbits inclination is 55°-56°. Longitude of the ascending node or right ascension of the ascending node (Ω): Angle between the reference plane's vernal point and the ascending node, measured CCW from vernal equinox. Argument of periapsis (@): angle measured from the ascending node to the periapsis, defining the orientation of the ellipse in the orbital plane. Mean anomaly: defines the position of the satellite along the ellipse at a precise epoch. It is not a geometric angle. However, it can be converted into the true anomaly (v) which is the angle between periapsis and the position of the orbiting object (satellite).

In one embodiment, the network can further classify the ephemeris information into two parts (1) common ephemeris information, and (2) satellite-specific ephemeris information. The ephemeris information could be provisioned to the UE using USIM or provided to the UE using SIB-9 or a dedicated NTN-specific SIB. Moreover, a combination of both provisioned and SIB based ephemeris information is also possible, where the UE initially tries to blindly use satellite information from USIM, and then use satellite ephemeris broadcast on SIB. Alternatively, instead of network explicitly providing the next cell information to UE, UE can use the satellite information to estimate the candidate cells for cell reselection along the LEO satellite's orbit.

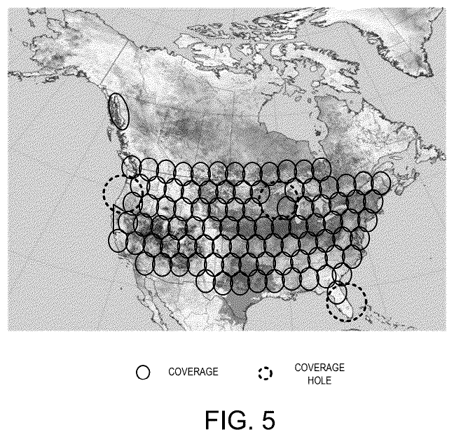

FIG. 5 illustrates embodiments of improved cell reselection under satellite coverage discontinuity in accordance with one novel aspect. For cell reselection, as signal strength, measured in terms of reference signal received power (RSRP) and reference signal received quality (RSRQ), falls below certain threshold, the UE starts measuring the signal strength and quality of neighboring cells. For inter-frequency reselection, the UE first selects the frequency having highest rank. Within the same frequency (for both inter-frequency and intra-frequency reselection), the UE ranks the cells based on their signal strength and re-selects the cell having the highest rank. The dynamics of signal strength and quality, measured in terms of RSRP and RSRQ could be quite different as there could be slow signal degradation, followed by abrupt loss of coverage of coverage holes.

In the embodiment of FIG. 5, using the same satellite ephemeris, the network can implicitly or explicitly indicate the UE about any upcoming coverage discontinuity (or coverage holes) and any geographical boundaries of home and roaming cells. LEO satellites can inform the geographical locations (e.g. areas, geographical coordinates, or time etc.) of these coverage holes to the UE and inform about impending beams (cells) that will provide the coverage to the UE in near future. The UE can perform reselection into these impending cells. Similarly, during the movement, if the LEO satellites coverage is going across the geographical boundary of a country, LEO satellites can inform the UE about this inter-country coverage and can assist the UE to reselect some other cells belonging to its home country.

When measurement conditions are met, UE starts to perform measurements over neighboring cells and derive RSRP and RSRQ measurement results for cell reselection. For example, the measurement conditions may include Srxlev or Squal of the serving cell is lower than a predefined threshold. In one embodiment, the existing measurement conditions (e.g. Srxlev, Squal) could be updated based on RSRP or RSRQ. For example, the existing measurement conditions could be updated to include weighted RSRP or RSRQ, where the weights are derived from the satellite ephemeris information, e.g. UE's location and UE's relative distance from the cell center. For example, comparing to a UE having small relative distance from the satellite, if a UE is having a large relative distance from the satellite, then it is likely for the UE to reselect a better cell quickly. Thus, depending on the relative distance the existing measurement, e.g. Srxlev, Squal could be weighted, e.g. UEs with low relative distance could use higher weights and UEs with high relative distance could use lower weights.

In another embodiment, the steps of improved cell re-selection, mentioned above, could be repeated at regular interval. As LEO satellite's speed, direction and beam-sizes are quite deterministic, the cell selection/re-selection instances and duration between successive re-selections are also deterministic. For example, the network can informs the UE about this regular interval using SIB-9 or NTN-specific SIB. Alternatively, the UE itself can calculate this regular interval using the satellite information.

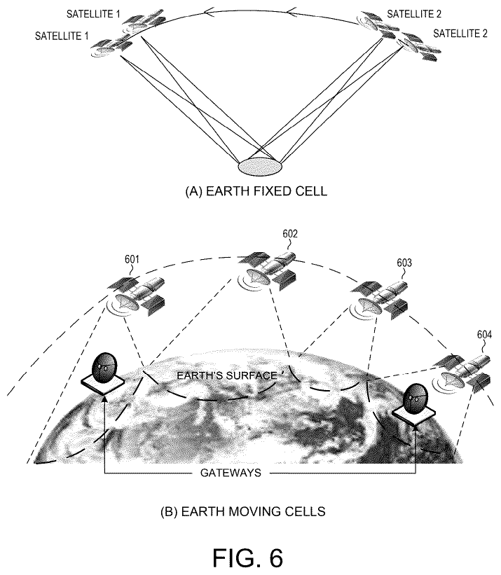

FIG. 6 illustrates examples of earth-fixed beams and earth-moving beams in LEO NTN and corresponding cell reselection procedure. As NTN could be comprised on earth-fixed and earth-moving beams, the network can explicitly inform the UE whether the LEO NTN is made up of earth-fixed beams (as depicted in (A), cell is fixed when satellite 1 and satellite 2 are moving) or earth-moving beams (as depicted in (B), cells are moving when satellites 601-604 are moving). Since satellites with earth-fixed beams are expected to experience less frequent cell reselection than satellites with earth-moving beams, a UE often prefers an earth-fixed beam (if available) over an earth moving beam for cell reselection. This could be efficiently done by network configuring RSRP and RSRQ thresholds differently for earth-fixed and earth-moving beams (by using RRC signalling) and thereby allowing the UE to reselect the earth-fixed beams with higher priority. Alternatively, if the earth-fixed and earth-moving beams are in different frequencies, the network can explicitly configure the earth-fixed beams with higher priority, thus enabling the UE to reselect the earth-fixed beams with higher priority over earth-moving beams.

The major existing threshold parameters, mentioned below, could be used and adjusted accordingly. (1) ThreshX, HighP: This specifies the Srxlev threshold (in dB) used by the UE when reselecting towards a higher priority RAT/frequency than the current serving frequency. Each frequency of NR and E-UTRAN might have a specific threshold. (2) ThreshX, HighQ: This specifies the Squal threshold (in dB) used by the UE when reselecting towards a higher priority RAT/frequency than the current serving frequency. Each frequency of NR and E-UTRAN might have a specific threshold. (3) ThreshX, LowP: This specifies the Srxlev threshold (in dB) used by the UE when reselecting towards a lower priority RAT/frequency than the current serving frequency. Each frequency of NR and E-UTRAN might have a specific threshold. (4) ThreshX, LowQ: This specifies the Squal threshold (in dB) used by the UE when reselecting towards a lower priority RAT/frequency than the current serving frequency. Each frequency of NR and E-UTRAN might have a specific threshold. (5) ThreshServing, LowP: This specifies the Srxlev threshold (in dB) used by the UE on the serving cell when reselecting towards a lower priority RAT/frequency. (6) ThreshServing, LowQ: This specifies the Squal threshold (in dB) used by the UE on the serving cell when reselecting towards a lower priority RAT/frequency.

Similarly, in a TN-NTN joint coverage area, as TN signals are expected to provide better coverage than NTN signals, a UE typically prefers a TN cell selection (if available) over an NTN cell selection. This could be efficiently done by the network configuring RSRP and RSRQ thresholds differently for TN and NTN cells (by using RRC signalling) to allow the UE to reselect the TN cells with higher priority. Alternatively, the network can also configure the TN cells with explicit higher priority, thus enabling the UE to reselect the TN cells with higher priority over NTN cells.

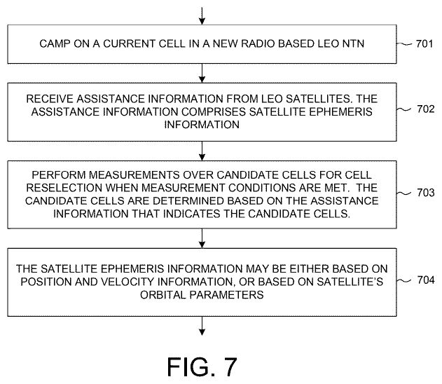

FIG. 7 is a flow chart of a method of performing improved cell reselection procedure in NR-based LEO NTN in accordance with one novel aspect. In step 701, a UE camps on a current cell in a new radio (NR) based Low Earth Orbit (LEO) Non-Terrestrial Network (NTN). In step 702, the UE receives assistance information from LEO satellites. The UE may stay in radio resource control (RRC) Idle mode, and the assistance information comprises satellite ephemeris information. In step 703, the UE performs measurements over candidate cells for cell reselection. The candidate cells are determined based on the assistance information that indicates the candidate cells. In one embodiment (704), the satellite ephemeris information may be either based on position and velocity (P,V) information, or based on satellite's detailed orbital parameters.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method comprising:
camping on a current cell by a user equipment (UE) in a new radio (NR) based Low Earth Orbit (LEO) Non-Terrestrial Network (NTN);
receiving assistance information from LEO satellites, wherein the assistance information comprises satellite ephemeris information; and
performing measurements over candidate cells for cell reselection, wherein the candidate cells are determined based on the assistance information that indicates the candidate cells, wherein the UE prioritizes earth-fixed cells over earth-moving cells for the cell reselection.

2. The method of claim 1, wherein the satellite ephemeris information is either based on position and velocity (P,V) information, or based on satellite orbital parameters.

3. The method of claim 1, wherein the assistance information further comprises second tier candidate cell information.

4. The method of claim 1, wherein the ephemeris information is provisioned to the UE via Universal Subscriber Identity Module (USIM), or provided to the UE via system information block (SIB) broadcasting.

5. The method of claim 1, wherein the UE uses the assistance information to estimate the candidate cells for cell reselection along the LEO satellite's orbit.

6. The method of claim 1, wherein measurement conditions are updated based on a reference signal received power or reference signal received quality (RSRP/RSRQ) derived from the ephemeris information.

7. The method of claim 1, wherein the UE performs cell reselection with a regular interval that is determined based on the LEO satellite's speed, direction and cell size.

8. The method of claim 1, wherein the ephemeris information further indicates any upcoming coverage hole and geographical boundaries of home cells and roaming cells.

9. The method of claim 1, wherein the satellite ephemeris information indicates details of any upcoming coverage hole or upcoming coverage discontinuity.

10. The method of claim 1, wherein the UE prioritizes TN cells over NTN cells for the cell reselection.

11. A User Equipment (UE), comprising:
a cell selection circuit that selects a current cell to camp on in a new radio (NR) based Low Earth Orbit (LEO) Non-Terrestrial Network (NTN);
a receiver that receives assistance information from LEO satellites, wherein the assistance information comprises satellite ephemeris information; and
a cell reselection circuit that performs measurements over candidate cells for cell reselection, wherein the candidate cells are determined based on the assistance information that indicates the candidate cells, wherein the UE prioritizes earth-fixed cells over earth-moving cells for the cell reselection.

12. The UE of claim 11, wherein the satellite ephemeris information is either based on position and velocity (P,V) information, or based on satellite orbital parameters.

13. The UE of claim 11, wherein the assistance information further comprises second tier candidate cell information.

14. The UE of claim 11, wherein the ephemeris information is provisioned to the UE via Universal Subscriber Identity Module (USIM), or provided to the UE via system information block (SIB) broadcasting.

15. The UE of claim 11, wherein the UE uses the assistance information to estimate the candidate cells for cell reselection along the LEO satellite's orbit.

16. The UE of claim 11, wherein measurement conditions are updated based on a reference signal received power or reference signal received quality (RSRP/RSRQ) derived from the ephemeris information.

17. The UE of claim 11, wherein the UE performs cell reselection with a regular interval that is determined based on the LEO satellite's speed, direction and cell size.

18. The UE of claim 11, wherein the ephemeris information further indicates any upcoming coverage hole and geographical boundaries of home cells and roaming cells.

19. The UE of claim 11, wherein the satellite ephemeris information indicates details of any upcoming coverage hole or upcoming coverage discontinuity.

20. The UE of claim 11, wherein the UE prioritizes TN cells over NTN cells for the cell reselection.
